(19) United States
(12) Patent Application Publication
(10) Pub. No.: US 2006/0099931 A1
(43) Pub. Date: May 11, 2006

(54) Automatic phone number to website linking system and method

(76) Inventor: Tony Trujillo, Pasadena, CA (US)

Correspondence Address: CHRISTIE, PARKER & HALE, LLP, PO BOX 7068, PASADENA, CA, 91109-7068, US

(21) Appl. No.: 11/272,291

(22) Filed: Nov. 9, 2005

Related U.S. Application Data
(60) Provisional application No. 60/626,153, filed on Nov. 9, 2004.
(60) Provisional application No. 60/637,783, filed on Dec. 21, 2004.

(51) Int. Cl. H04L 12/58

(52) U.S. Cl. 455/412.1

(57) ABSTRACT

A system and method for providing data to a phone user based on a phone number entered by the user. The phone may access a website or send a message to a remote site when the phone number is entered or a send command is received from the user. The website may be determined by constructing a universal resource locator from the phone number or by accessing a database using the phone number. Location information may also be used to provide information to the user specific to the user's location. In the alternative, interactive information may be automatically retrieved by the phone when a number is input using other communication channels including short messaging system (SMS) messages.

### CROSS-REFERENCE TO RELATED APPLICATION

This application is based upon and claims priority to U.S. Provisional Application No. 60/637,783, filed Dec. 21, 2004 and U.S. Provisional Application No. 60/626,153, filed Nov. 9, 2004, the content of both are incorporated by reference in their entirety.

### BACKGROUND

Telephones, cellular telephones (“cell phones”), smart phones, satellite phones, and a variety of other telemetric devices are now in common use among many callers. Internet enabled cell phones are also known in the industry. Internet enabled cell phones include browsing and displaying capabilities that allow a user to browse to an Internet location or website and display content from that site on the phone. Display of website content on the phone varies from color display, to black and white display, and may even be a text-only display. Other phones may be capable of displaying content from java or flash enabled websites or the like. Other phones may be capable of displaying multimedia or other content from websites.

Internet enabled phones may be mobile telephones. For example, some mobile telephones may be enabled for the Wireless Application Protocol (WAP). WAP enabled phones can access web content using a “mini browser” application built into the phone's interface. The web content streams in via the cellular network and is displayed by the telephone.

Presently, in order to display a particular website on the cell phone, a user must direct the phone's browsing feature to that website. For example, to access a site at www.ABC.com, the user must enter the URL (or a portion thereof) into the internet enabled phone and then request that the phone access and display that site. An automatic location of a particular website by the telephone, and an optional automatic display of the website to the user, would be advantageous.

### SUMMARY OF THE INVENTION

A method for automatically providing data to a phone including receiving a phone number from a user, retrieving data from a remote location based on the phone number, and displaying the data to the user. The phone may be a cellular or similar wireless mobile phone. In one embodiment, the phone number may be used to construct a URL to access or to look up a website in a database to access. In another embodiment, other communication paths and protocols may be used including short messaging system (SMS) messages to provide data to the user of the phone.

### BRIEF DESCRIPTION OF THE DRAWINGS

FIG. 1 is a diagram of one embodiment of a phone to Internet network.

FIG. 2 is a diagram of one embodiment of a typical website.

FIG. 3 is a flow chart of automatic phone number to website linking according to one embodiment of the invention.

FIG. 4. is a flow chart of automatic phone number to website linking according to one embodiment of the invention.

FIG. 5. is a flow chart of automatic phone number to website linking according to another embodiment of the invention.

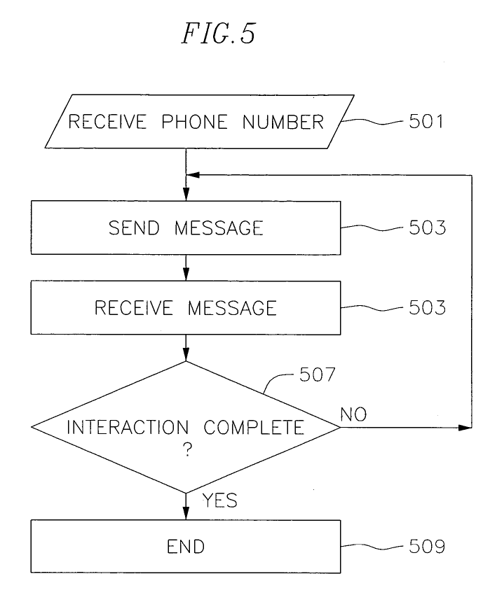

### DETAILED DESCRIPTION

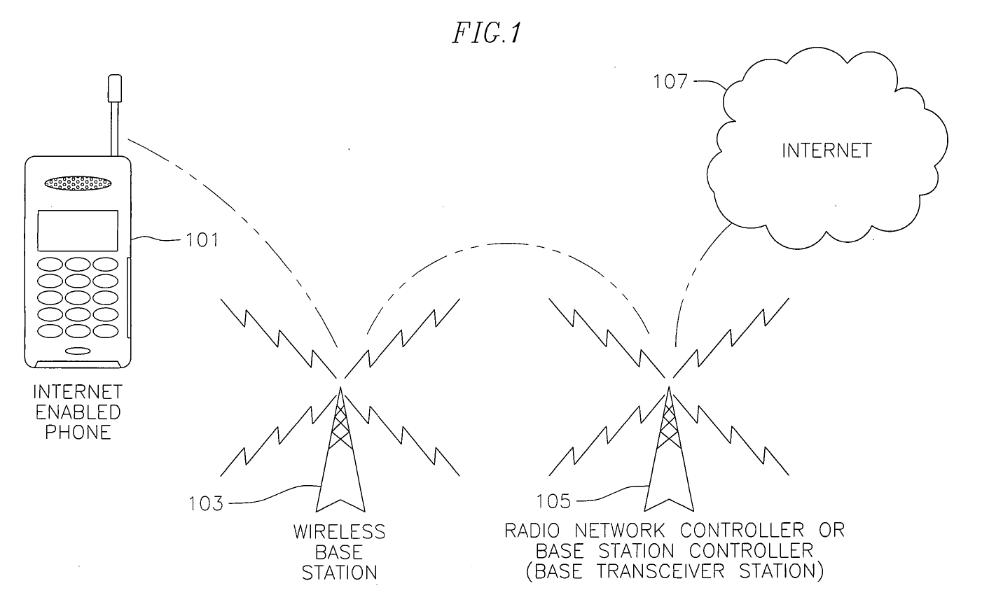

An internet enabled telephone contains usually a web-browsing application. In one example, the web-browsing application may use the Wireless Application Protocol (WAP), built into the phone's interface. If the phone 101 is wireless, as shown in FIG. 1, the phone's interface sends and receives signals to a wireless base station 103 (or a base station subsystem BSS), which then relays the signals to a base transceiver station 105 (BST), part of a base station controller (BST). Any other network configuration which would allow the internet-enabled phone to transmit requests to the Internet 107 and receive information from the Internet can be used. Other communication paths and protocols may also be used, including short messaging system messages (SMS) to provide data to the user of the phone. Throughout this application, the terms data, information, and content are used interchangeably and include such types of data/information/content as audio, video, images, audio/video, multimedia, applications, scripts, commands, addresses, any other type of data, information or content, or any combination of these types of data/information/content.

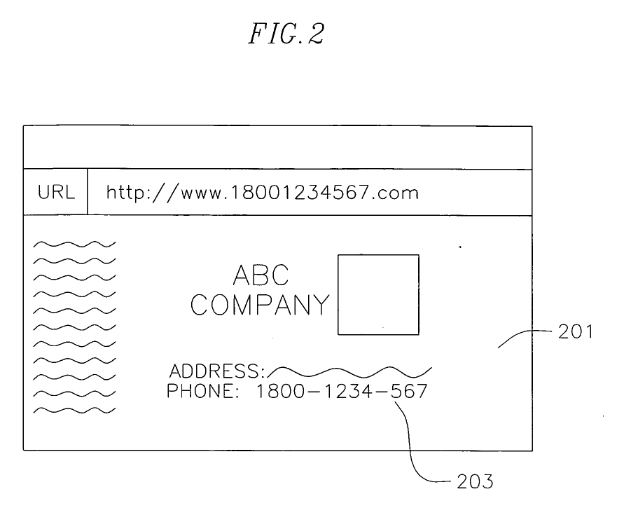

A company's website 201 can have company identifying information as can be seen in FIG. 2. For example, an ABC corporation (used here as purely a fictional corporation), may have a website located at www.ABC.com that displays, among other things, ABC corporation's phone number 203 on it.

According to an embodiment of the invention, a company website's address, or a uniform resource locator (URL), may resemble its phone number. That is, for example, if the phone number for ABC company is 1-800-1234-567, ABC company's website can be located at www.8001234567.com, as shown in FIG. 2. In a further embodiment, the website can be located at www.800-1234-567.com, www.800-1234567.com, or at a location with a similar URL. In an alternative embodiment, a website mimicking a company's phone number, such as the one located at www.80001234567.com, would redirect user's browser to ABC company's website located at another address or may direct the user's webpage to a specific webpage or resource within a website. In one example, pointing a website browser to a telephone-resembling URL, such as www.8001234567.com, would eventually display the website located at www.ABC.com. In another example, a user may be redirected to a specific webpage within a site that may be specifically generated for the user, such as www.ABC.com/mypage.html.

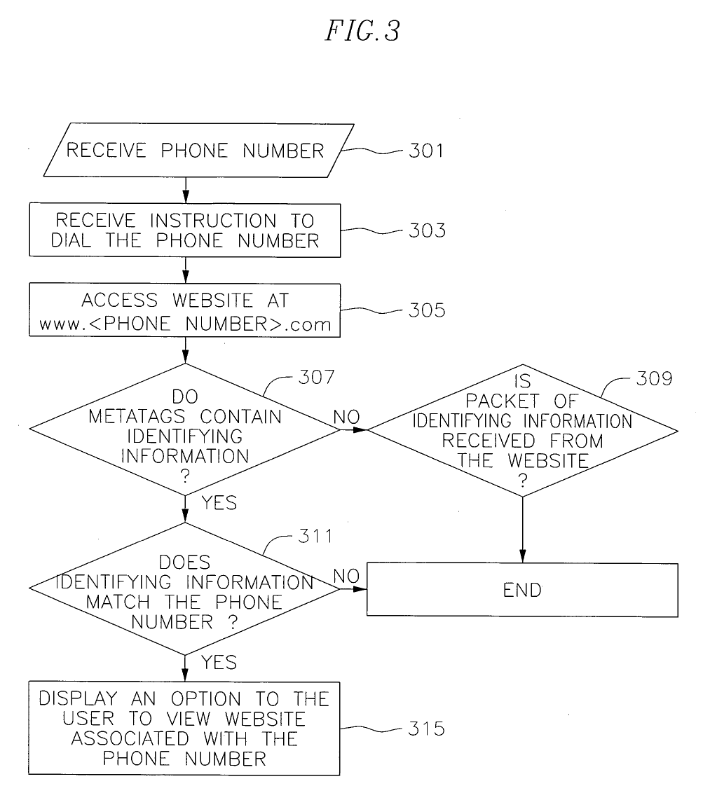

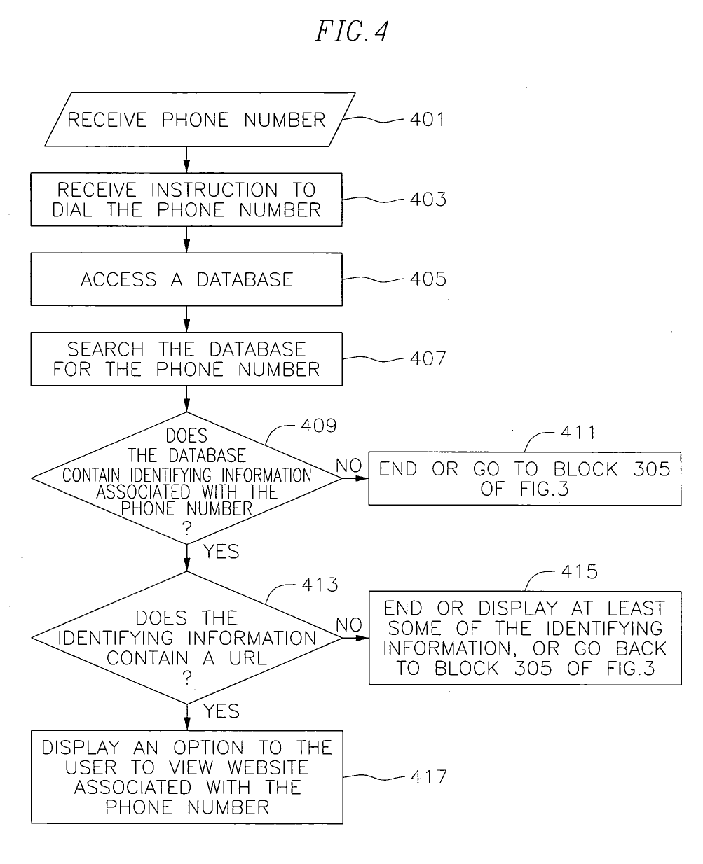

When a user dials a phone number on an Internet-enabled phone, the phone can alert the user if the phone number is associated with a particular company's website and query whether the user wants to display that website on the phone. At least two embodiments of this process are shown in FIGS. 3 and 4.

First, as shown in FIG. 3, the user dials a phone number (block 301). This may be accomplished by the user entering a phone number into an Internet-enabled phone and transmitting a “SEND” command to the phone (block 303). The phone receives the command to dial the phone number and dials that number. The phone also, at any time before, after or simultaneous with the time that the command to dial the phone number is received, may perform process illustrated in blocks 305-315 of FIG. 3. The phone may access a website located at www.<phone number>.com (block 305), where the “<phone number>” is the phone number entered by the user. In this embodiment, if a website, such as www.ABC.com, can be accessed by a phone number based domain name (e.g. wwww.8001234567.com) the ultimate destination website (www.ABC.com) may include a metatag identifying the website as a phone number related website. A browser program residing on the phone may access the metatags of the website and search the metatags for phone number related website identifying information (block 307). Alternatively, the identifying information can be located in another portion of the website. Usually, though, the location is one known to the phone's web browser or other software. If the identifying information is found, the process continues to the next step.

In an alternative embodiment, the identifying information is not in the webpage itself, but is contained in a specialized packet sent to the phone's web browser by the website in response to the request for the website made by the phone's browser (block 309). In this embodiment, in addition to or in place of searching the website's metatags, the browser program residing on the phone checks if a packet of information other than webpage packets has been received from the website. If such a packet of information is received from the website, the program checks for presence of identifying information in the packet. Such identifying information could contain the name of the company, the phone number or phone numbers associated with it, as well a URL of the company's main website.

In any of the various embodiments, if identifying information is received from the website and/or located in the website's metatags, the phone compares this information with the phone number entered by the user (block 311). For example, the phone may check to see if the phone number entered by the user is present, or partially present, in the identifying information. In one embodiment, the phone number entered by the user may have a company name associated with it. As an example, the phone can compare the company name with parts of the identifying information. In another embodiment, the metatag and/or packet includes a known code or word that is a representation by the website that it is correlated with the “phone number” domain name. In this case, the phone does not have to check any information in the metatag or packets with the “phone number” domain name used to access that website.

If a match, or a partial match, is obtained between the identifying information and the phone number (or the known code is present), the phone displays information on its display screen indicating to the user that a website associated with the phone number has been located (block 315). An option to display the located website is also presented to the user. For example, the phone may display an icon automatically hyperlinked to the located website, so that if the user activates the icon, the phone's web browser will display the associated website content. The icon, for example, may have a text or an image tag stating “click here to view company's website,” “press * to view company's website,” or the like.

In an alternative embodiment, rather than waiting for a user response to a cue, such as an icon, the phone's web browser is automatically launched and a website associated with the phone number called is displayed without any action by the user. In one embodiment, this automatic launching mode may be turned on or off selectively by the user, cell phone operator, or service provider.

FIG. 4 shows an alternative embodiment of automatic linking of phone numbers to websites on an internet enabled phone. A user enters a phone number (block 401) and submits a request for the phone to dial the phone number (block 403). The number is transmitted to the cell phone operator or provider, and a program located at the cell phone operator or service provider accesses a database (block 405) provided by the phone operator comprising a list of phone numbers and their identifying information. The identifying information comprises website(s) addresses, also known as URL(s), associated with the phone number. The identifying information can also contain other information, such as, for example company name and address. The program searches the database for the phone number entered by the user (block 407). If a match is found, the program checks whether a website address, or a URL, is associated with the phone number (block 409). That is, the program checks whether the identifying information associated with the phone number contains a URL address (block 413). If a URL is associated with the phone number, the program transmits information to the phone, which includes the associated URL address, and displays an icon on the phone screen indicating to the user that the associated URL has been found (block 417). The icon can be hyperlinked to the associated URL, and can indicate “click here to see the company's website,” “press * to see the company's website,” or a similar message. Upon activation of the icon by the user, the phone's browser is pointed to and displays the website content located at the associated URL.

In an alternative embodiment, when a user enters a phone number and the phone number is transmitted to the cell phone operator, a program residing at the cell phone operator searches a database for the phone number, and, if a match is found, the program transmits associated information to the phone. In this embodiment, the database of information, which may be provided by the phone service provider for example, contains associated information similar to that found on a website. For example, the database can contain a static copy of a webpage or a web-site associated with a particular phone number. As another example, the associated information can contain information such as location, local phone number/fax, description of services, restaurant menus, hours of operation, sales information, etc. This associated information may be transmitted to the phone in addition to, or instead of, the basic identifying information.

In an alternate embodiment, the phone includes a geographic locator such as a global positioning system (GPS) device for identification of the location of the transmission tower the phone is connected to, or any other geographic location technique. In this embodiment, if the phone number dialed relates to multiple geographic locations, such as a fast-food restaurant chain, the phone location is sent to the website associated with the dialed phone number. The phone location may be sent to the website before or after the website availability icon is selected by the phone's user. In this embodiment, the webpage sent to the user's phone is customized for the location of the phone. For example, in the case of a fast-food restaurant chain, the location and phone number of the nearest restaurant of the chain is identified in the customized webpage sent to the phone, along with menu items or specials that are particular for that local restaurant.

In a further embodiment, the phone has a geographic locator, such as GPS device for identification of the location of the transmission tower the phone is connected to, and a cell phone operator has a program for accessing a database. When a user enters a phone number, the location of the phone is provided to the database and the program searches the database for the phone number. If a match is found, associated information based on the location of the phone is identified or determined, and the associated information based on the location of the phone is transmitted back to the phone. In this embodiment, the database, which may be provided by the phone service provider for example, contains information associated with the dialed phone number similar to that which can be found on a website, and such associated information can also depend on the location of the phone. Accordingly, in this embodiment, the associated information sent to the user's phone is customized for or selected based on the location of the phone. For example, the database can contain a copy of a webpage or a web-site associated with a particular phone number. The webpage contained in the database may be dynamic and change based on the physical location of the phone. As another example, the associated information may contain information such as location/address, local phone or fax number, description of services, restaurant menus, hours of operation, sales information, etc. If the phone number dialed relates to multiple geographic locations, such as a fast-food restaurant chain for example, the database may contain a listing of various menus or specials associated with their respective physical locations. As another example, if the associated information contains a listing of addresses associated with the phone number, address closest to the location of the phone may be included in the associated information based on the location of the phone transmitted back to the phone.

In further alternative embodiments, the program for searching the database may reside on the cell phone. In these embodiments, the program accesses and searches the database and then receives or downloads results containing the identifying information and/or the associated information to the phone. In yet other embodiments, the program and the database may be located on the phone.

The option of automatic linking may be limited to instances where the phone number entered by the user is a toll free phone number in order to stop the phone from attempting to access websites or a database when dialing private individuals. Alternatively, the automatic linking may be provided as an option that can be disabled prior to and/or during dialing of the phone number.

In another embodiment, the automatic linking of an input phone number may not rely on a connection through the Internet to provide information to the user. The exchange of information with the phone may utilize alternative protocols and communications paths. For example, the system may utilize short messaging service (SMS), extended SMS, Bluetooth, cellular communication networks, similar wireless communications systems and combinations thereof. The process may be initiated by the entering of a phone number into the phone (block 501). The phone may then automatically send a message to the entered number, a related number or a known number of a processor, for example that may be provided by the phone service operator (block 503). The phone may wait to send the number until the phone call is initiated or connected. The message may be an SMS message, an extended SMS message, a specialized packet or similar data format dependent on the network over which the message is transferred. The message may contain information identifying the caller or similar information. This communication process may proceed simultaneous with a standard telephone call.

The message may be received and processed by the entity to which the destination phone number belongs, or may be intercepted by a service provider or similar third party for processing. In response to the received message, the message processor may send a return message including an SMS message, a specialized data packet, a URL, a webpage, multimedia, images, movies, songs, games, videos, video games, or similar data associated with the number entered by the user. The returned message or data may cause the phone to initiate a browser, media player or similar application on the phone. In one embodiment, the message processor may generate an SMS or extended SMS message to be returned to the user phone, the message may include a menu of options through which the user can continue interaction. In another example, the returned message may contain a URL for a website associated with the phone number and automatically initiate a web browser to view the website.

In one embodiment, continued interaction through the Internet or through the alternate communication protocols and systems may continue until the user has completed her interaction with the system (block 507). The user and processor may communicate through different communication networks or protocols, for example the user may send SMS messages and receive Internet packet data through the cellular network. If a user has completed its interaction, the communication with the message processor may be terminated automatically by the transmission source or by the user (block 509).

In one embodiment, the alternative communication system may be used in connection with location data such as GPS data provided by a device in the phone or nearest tower to provide information to the user that is specific to the locality of the user. For example, a call to a national pizza restaurant chain may cause a menu, or selection of specials to be sent to the phone to be displayed to the user that is specific to the local restaurant belonging to the chain.

In one embodiment, information may be sent to the phone upon the receipt of a phone call. The same system and process may be employed to provide website content to a phone when the call is initiated by someone other than the user. The user may decline to receive the incoming phone call and may separately be prompted to decide whether to receive the accompanying data. For example, a customer service call may be made to a user to offer a service or follow up on previously provided service. Information from the service provider may be sent at the time of the call or after the initiation of the call. The data sent may include billing information, special offers or similar information.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

What is claimed is:

1. A method for automatically providing data to a phone:
receiving a phone number from a user;
retrieving data automatically from a remote location based on the phone number; and
displaying the data to the user.

2. The method of claim 1, further comprising:
searching a database remote from the phone to locate the phone number.

3. The method of claim 2, further comprising:
providing an identification of a website to the user associated with the phone number.

4. The method of claim 3, further comprising:
verifying the website is associated with the phone number.

5. The method of claim 1, wherein retrieving data from a remote location comprises accessing a website with the phone number in a universal resource locator.

6. The method of claim 1, further comprising:
providing an option to the user to view retrieved data.

7. The method of claim 1, further comprising:
determining global positioning data related to the phone.

8. The method of claim 7, wherein retrieved data is localized based on the global positioning data.

9. The method of claim 1, further comprising:
sending a first short messaging system message including the phone number.

10. The method of claim 9, further comprising:
receiving a second short messaging system message with data related to the phone number.

11. A method for operating a phone comprising:
receiving a phone number from a user;
determining a website to access automatically using the phone number;
receiving data from the website; and
displaying the data to the user via the phone.

12. The method of claim 11, further comprising:
constructing a universal resource locator using the phone number.

13. The method of claim 12, further comprising:
accessing the website using the universal resource locator.

14. The method of claim 11, further comprising:
checking metatags of the website for the phone number.

15. The method of claim 11, further comprising:
displaying an option to the user to view the website.

16. The method of claim 11, further comprising:
searching a database for the phone number.

17. A method for providing interactive content to a phone user comprising:
receiving a phone number from a user;
sending a first short messaging system message automatically to a remote site based on the phone number; and
receiving a message from the remote site providing data related to the phone number.

18. The method of claim 17, wherein the data is a menu of options.

19. The method of claim 17, wherein the message is a second short messaging system message.

20. The method of claim 19, further comprising:
sending a third short messaging system message to the remote site based on user input.
